(19) United States
(12) Patent Application Publication
(10) Pub. No.: US 2022/0129518 A1
(43) Pub. Date: Apr. 28, 2022

(54) SYSTEM AND METHOD FOR PROVIDING BOOK-BASED PERSONALIZED SOCIAL MEDIA SERVICE

(71) Applicant: FANTORS CO., LTD., Seoul (KR)

(72) Inventors: Yong-Se KIM, Hwaseong-si (KR); Sung-Ki CHUN, Hwaseong-si (KR)

(73) Assignee: FANTORS CO., LTD., Seoul (KR)

(21) Appl. No.: 17/572,420

(22) Filed: Jan. 10, 2022

Related U.S. Application Data
(63) Continuation of application No. PCT/KR2020/009157, filed on Jul. 13, 2020.

(30) Foreign Application Priority Data
Jul. 12, 2019 (KR) 10-2019-0084140

(51) Int. Cl. G06F 16/957; G06F 16/958; H04L 51/52

(52) U.S. Cl. CPC G06F 16/9577; H04L 51/32; G06F 16/958

(57) ABSTRACT

A system and method for providing a book-based personalized social media service is proposed. The system and method for providing a book-based personalized social media service enables a user to write and post, in the form of a book including a plurality of various pieces of content, a post to be posted on a social media web page that provides the social media service, and manage the book, which is a personally posted post, through management tools in the form of a library and a bookshelf, so as to freely implement and share the content.

### CROSS-REFERENCE TO RELATED APPLICATIONS

The present application is a continuation of International Patent Application No. PCT/KR2020/009157, filed Jul. 13, 2020, which is based upon and claims the benefit of priority to Korean Patent Application No. 10-2019-0084140 filed on Jul. 12, 2019. The disclosures of the above-listed applications are hereby incorporated by reference herein in their entirety.

### TECHNICAL FIELD

The present disclosure relates to a system and method for providing a book-based personalized social media service and, more particularly, to a system and method for providing a book-based personalized social media service, the system and method enabling a user to write and post, in the form of a book including a plurality of various pieces of content, a post to be posted on a social media web page that provides the social media service, and manage the book, which is a personally posted post, through management tools in the form of a library and a bookshelf, so as to freely implement and share the content.

### BACKGROUND ART

In general, social media refers to online tools or platforms which are used to broaden interpersonal networks while sharing people's opinions, thoughts, experiences, and perspectives. These social media are provided through various pieces of content such as text, images, audio, and video, and are typically blogs, message boards, podcasts, wikis, vlogs, and social networking services (SNS) such as Twitter and Facebook, etc.

These social media are being used as information sharing, advertising, and public relations media, which share various information in various fields for individuals, companies, and countries.

In the social media, more than 1.6 million posts per day, i.e., more than 500 million posts per year, are uploaded and posted through 150 million blogs, more than 1.5 billion Facebook posts are made by 500 million users every day, 140 million tweets are posted every day, and more than 2 million YouTube videos are uploaded every day.

In addition, people have more than one social media subscription each, and a number of posts such as homepages, blogs, tweets, and videos are registered every day in various social media sites.

A typical system for providing social media service may usually upload a single-page post to a single post web page.

Accordingly, in a case of posting lengthy pieces of information in the typical system for providing social media service or posting pieces of divided information in multiple times, the posting of the information has to be performed by writing and uploading a plurality of posts, or writing a new post including new information to update an existing post previously posted, or generating and uploading a plurality of pages based on an index before allowing each page to be transitioned by selection of the index.

As described above, in the case of posting lengthy pieces of information in the conventional system for providing social media service or posting pieces of divided information in multiple times, the posting of the information is performed by writing and uploading the plurality of posts, or writing a new post including new information to update an existing post previously posted, or registering each post on the basis of the index and allowing the post to be transitioned by the selection of the index, so there is a problem that it is difficult to provide associations between posts, and it takes a lot of work time to write and upload the posts.

In addition, in the case of uploading posts to another system for providing a social media service, the posts uploaded to the conventional system for providing social media service may respectively have links established through sharing, but in a case of registering actual posts rather than the links, the posts should be newly written according to a format corresponding to the relevant system for providing the social media service, so there is a cumbersome problem from a user's point of view.

### DISCLOSURE

### Technical Problem

Accordingly, an objective of the present disclosure is to provide a system and method for providing a book-based personalized social media service, the system and method enabling a user to write and post, in the form of a book including a plurality of various pieces of content, a post to be posted on a social media web page that provides the social media service, and manage the book, which is a personally uploaded post, through management tools in the form of a library and a bookshelf, so as to freely implement and share the content.

### Technical Solution

According to the present disclosure for achieving the above objectives, there is provided a system for providing a book-based personalized social media service, the system including: a communication unit configured to perform data communication with a plurality of connected user terminal units; a storage unit comprising a post DB configured to store posts, posted on a social media web page, for each timeline and each user, and a book DB configured to store a book created for each user, and store book management information for each user for the created book; and a controller configured to provide, to each connected user terminal unit, the social media web page on which a plurality of posts is posted, provide a post writing GUI including a book creation GUI upon request for creating the book, create a two or more page book that performs page transitions by turning pages within a same post through the book creation GUI, so as to store the book in the book DB, generate management information for the created book according to user's selection, maps management information for each user to one or more books of each user, so as to store a mapped result in the book DB before posting the created book on the social media web page as a post, and provide each connected user terminal unit with a book viewer enabling the page transitions by the turning of the pages when the book is selected, so as to enable each user to view a plurality of book pages of the book.

The controller may include: a platform provision unit configured to provide, to each connected user terminal unit, the social media web page on which the plurality of posts is posted, and provide the book viewer when the posted posts are books; a post event monitoring unit configured to monitor whether a post event for requesting writing of a post on the social media web page occurs; a post generation unit configured to provide the post writing GUI including the book creation GUI, and create the two or more page book that performs the page transitions by the turning of the pages within the same post through the book creation GUI, so as to store the book in the book DB, when the post event occurs through the post event monitoring unit; a post web page generation unit configured to generate the social media web page including the created book as the post, so as to store the social media web page in the post DB, and then provide the social media web page to each user terminal unit; and a management means generation unit configured to generate the management information for the created book according to each user's selection, and map the management information for each user to one or more books of each user, so as to store the mapped result in the book DB.

The platform provision unit may include: a web page provision unit configured to provide, to each connected user terminal unit, the social media web page on which the plurality of posts is posted; and a book viewer provision unit configured to provide the book viewer for performing a plurality of page transitions by the turning of the pages within one post when a selected post is a book type post in a case of selecting the post on the social media web page provided through the web page provision unit.

The post generation unit may include: a web post generation unit configured to provide a post generation GUI to each connected user terminal unit and generate a general post through the post generation GUI when the post event is a general post writing event in a case where the post event occurs through the post event monitoring unit; and a book generation unit configured to provide the book creation GUI to each user terminal when the post event is a book creation event, and create the two or more page book that performs the page transitions by the turning of the pages within the same post through the book creation GUI, so as to store the book in the book DB.

The book creation unit may include: a book page generation unit configured to provide the book creation GUI to each connected user terminal unit, and generate and provide blank book pages together when the book creation event occurs; a text writing unit configured to receive input text by providing a text box when each user selects to write the text, receive a designated position of the text box in each book page, and arrange the text box at the position of each book page, so as to arrange the text at the designated position; a content attachment unit configured to receive selection of content from each user when each user selects to attach the content, receive a designated position within each book page to which the content is to be attached, and attach the content to the designated position; and a book page combination unit configured to create the book by combining at least two or more book pages when the creating of each book pages is completed.

The content may be an image, a video, or a document, and the content attachment unit may include any one or more of the following: an image attachment unit configured to insert and attach the image, which is the content selected by each user, to an arbitrary position within each book page according to each user's selection, or attach the image as an attached file; a video attachment unit configured to insert and attach the video, which is the content selected by each user, to the arbitrary position within each book page according to each user's selection, or attach the video as the attached file; a document attachment unit configured to insert and attach the document, which is the content selected by each user, to the arbitrary position within each book page according to each user's selection, or attach the document as the attached file; and a link attachment unit configured to insert and attach a link for storing any one of the image, video, and document, which are the content selected by each user, to the arbitrary position within each book page according to each user's selection.

The book creation unit may further include an image edition unit configured to load and display the image attached in a form of insertion or a file through the image attachment unit, provide an image edition GUI capable of editing any one or more of a size, resolution, color, saturation, brightness, a layer, transparency, and an outline shape of the loaded image, and reapply the image edited through the image edition GUI to each book page.

The management means generation unit may include: a timeline generation unit configured to generate management information in which books created for each user are arranged in a timeline order, so as to store the management information in the book DB; and a library generation unit configured to generate a library including the management information in which the books are arranged according to setting information set by each user for the books created for each user, so as to store the library in the book DB.

The management means generation unit may further include: a bookshelf generation unit configured to group the books selected by each user among the books included in the library, generate a bookshelf including the grouped books, so as to register the bookshelf in the library.

According to the present disclosure for achieving the above objectives, there is provided a method for providing a book-based personalized social media service, the method including: providing a platform, wherein, a controller provides, to connected user terminal units, a social media web page on which a plurality of posts is posted, and provides a book viewer when the posted posts are books; monitoring a post event, wherein the controller monitors whether the post event for requesting writing of each post on the social media web page from each user terminal unit occurs through a post event monitoring unit; generating each post, wherein when the post event occurs through the post event monitoring unit, the controller provides a post writing GUI including a book creation GUI to each user terminal unit through a post generation unit, and creates a two or more page book that performs page transitions by turning pages within a same post through the book creation GUI, so as to store the book in a book DB; generating a post web page, wherein the controller generates the social media web page including a book generated through the post web page generation unit as each post, so as to store the social media web page in a post DB, and then provides the generated social media web page to each user terminal unit; and generating a management means, wherein the controller generates management information for the created book according to user's selection through the management means generation unit, and maps the management information for each user to one or more books of each user, so as to store a mapped result in the book DB.

The providing of the platform may include: providing a web page, wherein the platform provision unit of the controller provides the social media web page in which the plurality of posts is posted to each user terminal unit connected through the web page provision unit; and providing the book viewer, wherein when the selected post is a book-type post in a case where a post on the social media web page provided through the web page provision unit is selected, the platform provision unit of the controller provides the book viewer that performs a plurality of page transitions by the turning of the pages within one post through a book viewer provision unit.

The generating of the post may include: generating a web post, wherein when the posting event is a general posting event in a case where the post event occurs through the post event monitoring unit, the post generation unit provides a post generation GUI to each user terminal unit through a web post generation unit, and generates a general post through the post generation GUI; and generating a book, wherein when the post event is a book creation event, the post generation unit provides the book creation GUI to each user terminal unit through a book creation unit, and creates the two or more page book that performs the page transitions by the turning of the pages within the same post through the book creation GUI, so as to store the book in the book DB.

The creating of the book may include: generating book pages, wherein when the book creation event occurs, the book creation GUI is provided to each user terminal unit, and a blank book page is generated and provided together; writing text, wherein when each user selects to write the text, a text box is provided, so as to input the text, a position of the text box is designated within the book page, the text box is arranged at the designated position, so as to arrange the text at the designated position; attaching content, wherein when each user selects to attach the content, the content is selected from each user, a position in the book page to which the content is to be attached is designated, and the content is attached to the designated position; and combining the book pages, wherein when the generation of the book pages is completed, at least two or more book pages are combined so as to create a book.

The content may be an image, a video, or a document, and the attaching of the content may include any one or more of the following: attaching an image, wherein the image, which is the content selected by each user, is inserted and attached to an arbitrary position in the book page according to each user's selection, or is attached as an attached file; attaching a video, wherein the video, which is the content selected by each user, is inserted and attached to the arbitrary position in the book page according to each user's selection, or is attached as the attached file; attaching a document, wherein the document, which is the content selected by each user, is inserted and attached to the arbitrary position in the book page according to each user's selection, or is attached as the attached file; and attaching a link, wherein the link for storing any one of the image, video, and document, which are the content selected by each user, is inserted and attached to the arbitrary position in the book page according to each user's selection.

The creating of the book may further include editing an image, wherein the image attached in a form of insertion or a file is loaded and displayed through the image attachment unit, an image edition GUI capable of editing any one or more of a size, resolution, color, saturation, brightness, a layer, transparency, and an outline shape of the loaded image is provided, and the image edited through the image edition GUI is reapplied to the book page.

The generating of the management means may include: generating a timeline, wherein the management information in which books created for each user are arranged in a timeline order is generated, so as to store the management information in the book DB; and generating a library, wherein the library including the management information in which the books are arranged according to setting information set by each user for the book created for each user is generated, so as to store the library in the book DB.

The generating of the management means may further include generating a bookshelf, wherein the books selected by each user among the books included in the library is grouped, the bookshelf including the grouped books is generated, so as to register the bookshelf in the library.

### Advantageous Effects

The embodiment of the present disclosure provides a post posted on a social media web page provided by the system for providing social media service in the form of a book, so a plurality of consecutive posts, i.e., pages, may be packaged in a single post, whereby there is an effect that a storytelling post may be easily written.

In addition, the embodiment of the present disclosure has an effect that content may be more correctly spread through a combination of a social network service and a media content platform.

In addition, the embodiment of the present disclosure provides a post in the form of a book, so the pages of the post in which a number of pages are packaged into one book may proceed by turning pages from left to right, or right to left even when the entire timeline is scrolled up and down, whereby there is an effect that the post is not constrained by space.

In addition, the embodiment of the present disclosure manages a post in the form of a book and manages the post through interfaces of a library and a bookshelf, so there is an effect that a user may easily understand and manage his or her own post from a user's point of view.

In addition, the embodiment of the present disclosure manages a post managed through any one or more of a bookshelf and a library in the form of a book and may easily upload the post to another system for providing social media service, so there is an effect that not just a simply shared post but a new post of the same content may be easily generated.

In addition, just as a full-page advertisement is taken for granted when viewing a magazine, the embodiment of the present disclosure may naturally expose an advertisement on a full page also in a book while turning the pages over, so there is an effect that advertising efficiency may be maximized.

In addition, in the embodiment of the present disclosure, a post is provided in the form of a book, wherein not just text, but static images, videos, links, and files (i.e., word files, graphic files, etc.) may be inserted, attached, or linked to each page of the book, so a more powerful post may be provided, whereby there is an effect that the effectiveness of an advertisement may be improved when providing the advertisement.

### DESCRIPTION OF DRAWINGS

FIG. 1 is a view illustrating a configuration of a communication system to which a system for providing a book-based personalized social media service is applied according to the present disclosure.

FIG. 2 is a view illustrating a detailed configuration of a social media service provision server of the system for providing the book-based personalized social media service according to the present disclosure.

FIG. 3 is a view illustrating a detailed configuration of a book creation unit of the social media service provision server according to the present disclosure.

FIG. 4 is a view illustrating a book creation graphic user interface (GUI) provided by the social media service provision server according to an exemplary embodiment of the present disclosure.

FIG. 5 is a view illustrating a social media web page on which a book-based post is posted according to the exemplary embodiment of the present disclosure.

FIG. 6 is a view illustrating a configuration of a book-type post of the social media web page according to the exemplary embodiment of the present disclosure.

FIG. 7 is a view illustrating examples of a library and a bookshelf provided by the system for providing the book-based personalized social media service according to the present disclosure.

FIG. 8 is a view illustrating an example of customizing the bookshelf of the library provided by the system for providing the book-based personalized social media service according to the present disclosure.

FIG. 9 is a flowchart illustrating a method of providing a book-based personalized social media service according to the present disclosure.

FIG. 10 is a flowchart illustrating a book creation method of the method for providing the book-based personalized social media service according to the present disclosure.

### BEST MODE

Hereinafter, a configuration and operation of a system for providing a book-based personalized social media service according to the present disclosure will be described in detail with reference to the accompanying drawings, and a method for providing a book-based personalized social media service in the system will be described.

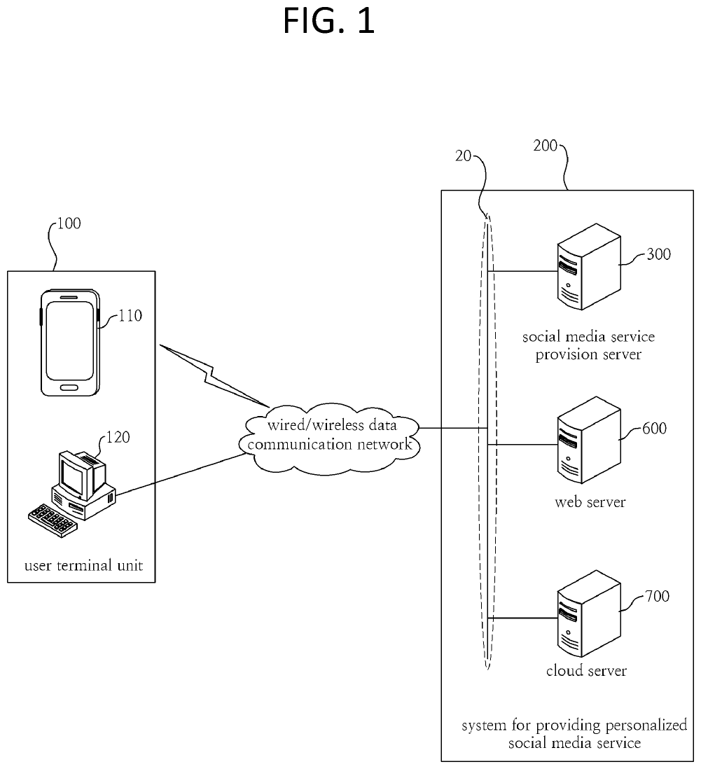

FIG. 1 is a view illustrating a configuration of a communication system to which the system for providing the book-based personalized social media service is applied according to the present disclosure.

The system 200 for providing the book-based personalized social media service according to the present disclosure is connected to a plurality of user terminal units 100 used by users through a wired/wireless data communication network 10, so as to perform mutual data communication.

The wired/wireless data communication network 10 is data communication network combined with at least any one or more of an Internet network including a Wi-Fi network, a mobile communication network including a third generation of wireless mobile telecommunications technology (3G), 4G, 5G, and the like, a WiBro network, a dedicated network, and the like.

The user terminal unit 100 is any one of a smart terminal 110 such as a smart phone or a smart pad, and a computer terminal 120 such as a desktop computer, a personal computer, a notebook computer, displays a book-based social media web page by connecting to the system 200 for providing the personalized social media service of the present disclosure, and performs at least two or more page transitions by turning pages within one post through a book viewer when the selected post is a book-type post including two or more book pages, thereby displaying information on the corresponding book page.

The system 200 for providing the personalized social media service may be configured and operated by a social media service provision server 300 alone, or may be composed of the social media service provision server 300 and a web server 600 so as to interwork with each other, or may further include a cloud server 700 according to the exemplary embodiment. In the case where the social media service provision server 300 is configured alone, the social media service provision server 300 should be configured to perform all functions of the web server 600.

The cloud server 700 is a personal cloud server, and stores individual books, libraries, bookshelves, and content, which are generated by the social media service provision server 300 by interworking with the social media service provision server 300.

The personalized social media service provision system 200 provides, to the connected user terminal unit 100, a social media web page in which a plurality of posts is posted, provides a post writing GUI including a book creation graphic user interface (GUI) upon request for book creation, creates a two or more page book that performs page transitions by turning pages within the same post through the book creation GUI, so as to store the book in a book DB, generates management information for the created book according to user's selection, maps the management information for a user to one or more books of the user, so as to store a mapped result in the book DB, and posts the created book as a post on the social media web page.

In addition, the system 200 for providing the personalized social media service may be configured to post, as a post on the social media web page, a book as well as a bookshelf including one or more books, provide a bookshelf viewer means when selecting the bookshelf to select an arbitrary book on the bookshelf, and drives a book viewer for the selected book to provide a selected book page to a user terminal unit 100.

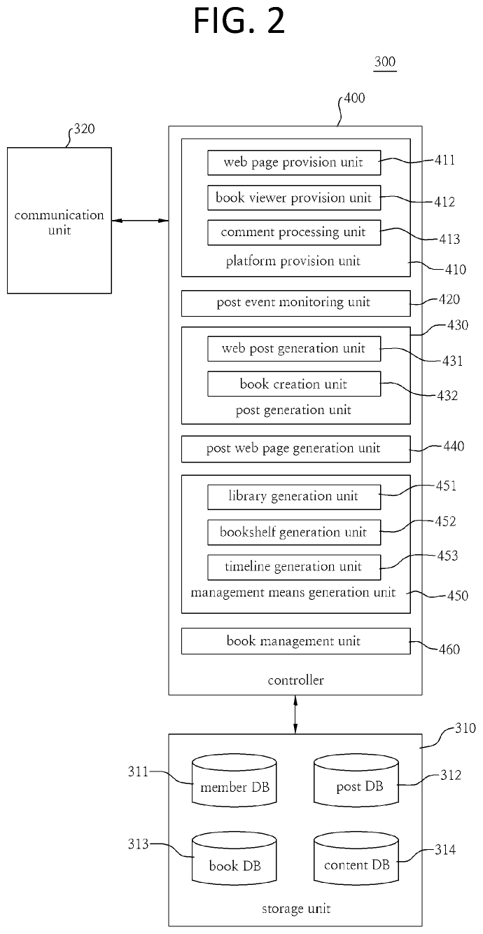

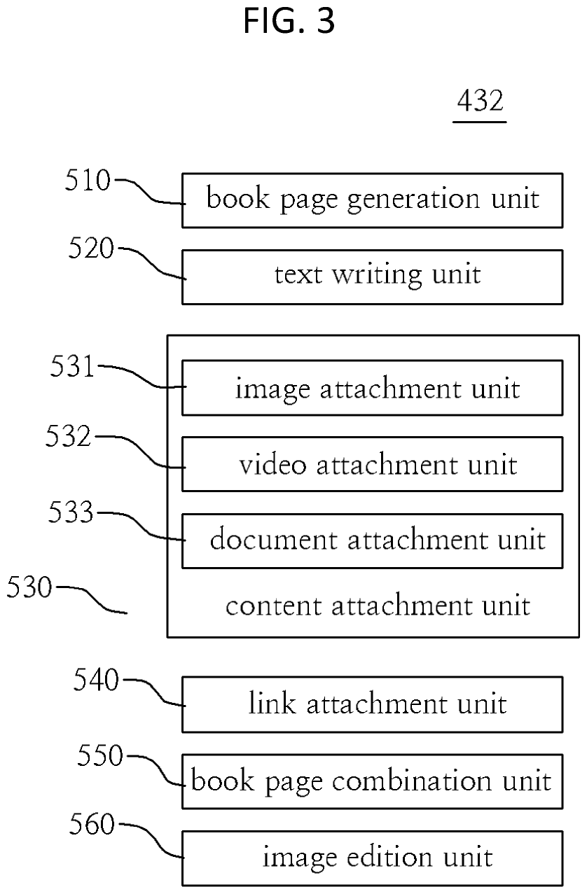

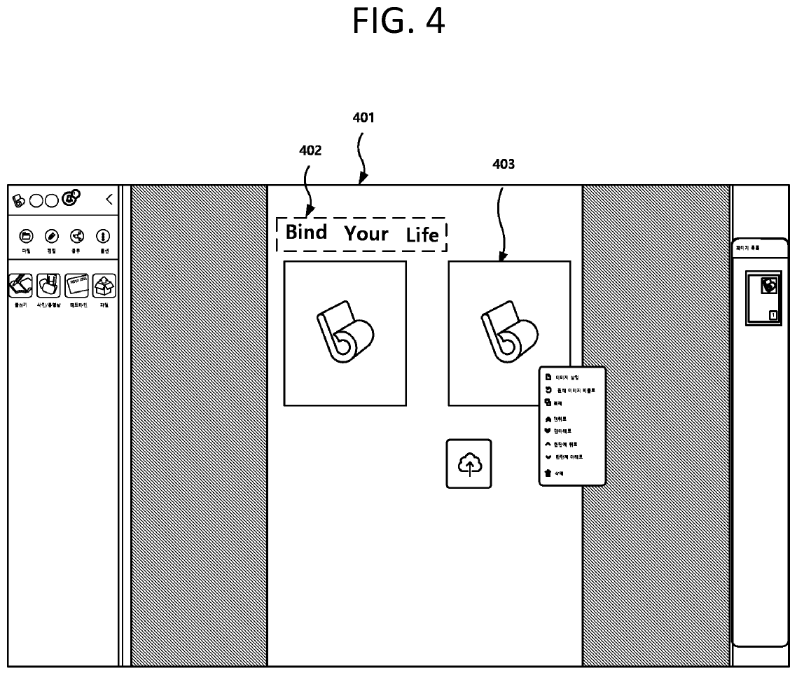

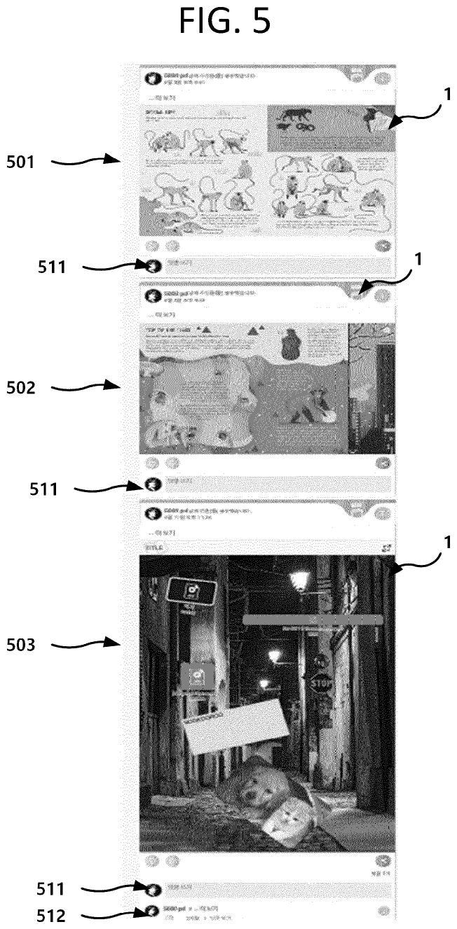

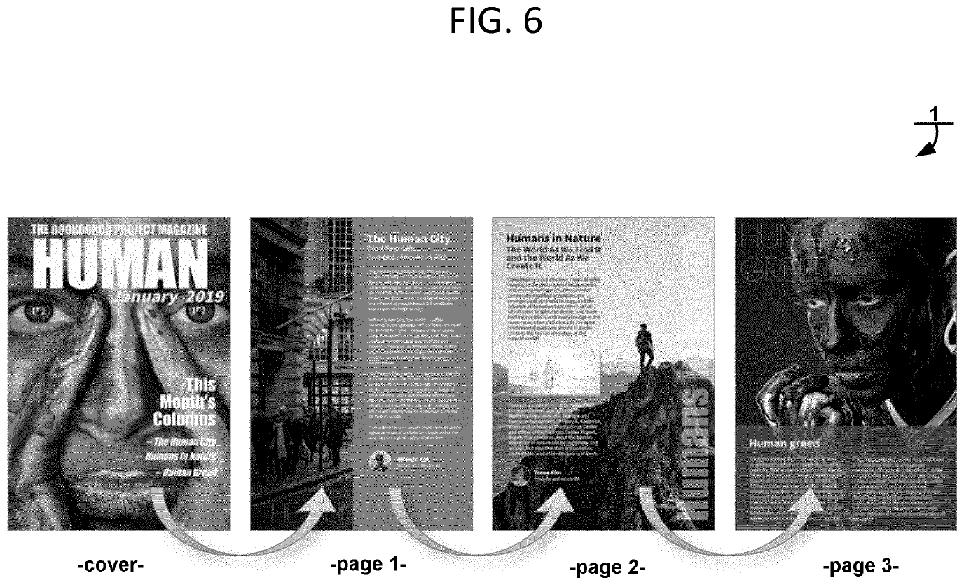

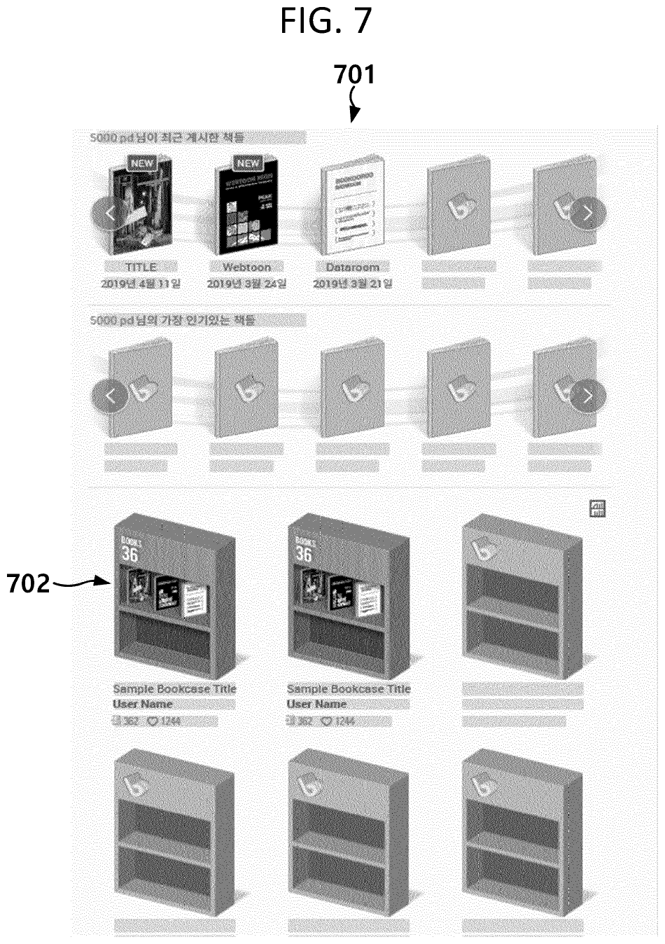

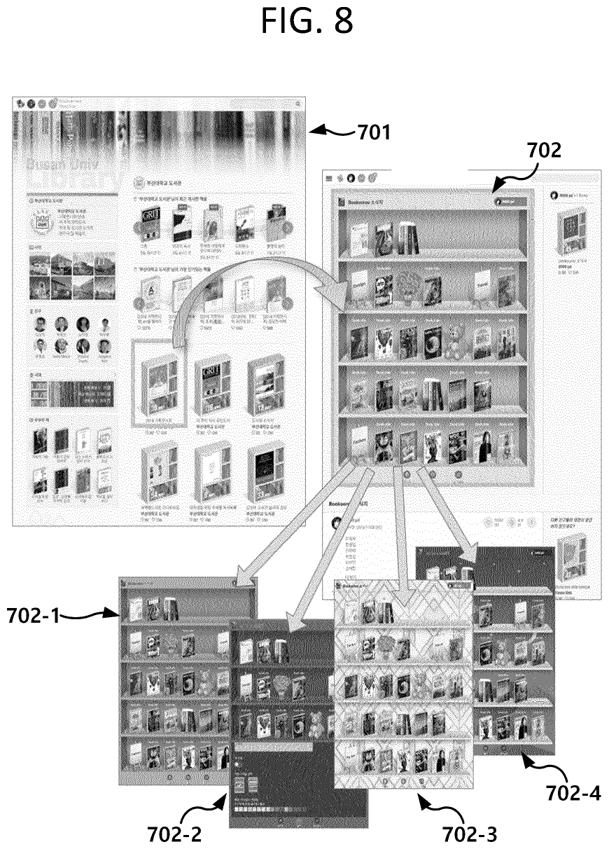

FIG. 2 is a view illustrating a detailed configuration of a social media service provision server of the system for providing the book-based personalized social media service according to the present disclosure, FIG. 3 is a view illustrating a detailed configuration of a book creation unit of the social media service provision server according to the present disclosure, FIG. 4 is a view illustrating a book creation graphic user interface (GUI) provided by the social media service provision server according to an exemplary embodiment of the present disclosure, FIG. 5 is a view illustrating a social media web page on which a book-based post is posted according to the exemplary embodiment of the present disclosure, FIG. 6 is a view illustrating a configuration of a book-type post of the social media web page according to the exemplary embodiment of the present disclosure, FIG. 7 is a view illustrating examples of a library and a bookshelf provided by the system for providing the book-based personalized social media service according to the present disclosure, and FIG. 8 is a view illustrating an example of customizing the bookshelf of the library provided by the system for providing the book-based personalized social media service according to the present disclosure. Hereinafter, the present disclosure will be described with reference to FIGS. 2 to 8.

The social media service provision server 300 includes a storage unit 310, a communication unit 320, and a controller 400, and is configured to provide the social media web page in which a plurality of posts is posted to the user terminal unit 100 connected directly or in conjunction with a web server 600, provide the post writing GUI including the book creation graphic user interface (GUI) upon request for book creation, generate the two or more page book that performs page transitions by turning pages within the same post through the book creation GUI, so as to store the book in the storage unit 310, generate the management information for the created book according to the user's selection, and post the created book or the bookshelf including two or more books on the social media web page, as a post. The management information may include timeline management information, library management information, bookshelf management information, and the like.

Specifically, according to the exemplary embodiment of the present disclosure, the storage unit 310 includes: a program area configured to store a control program for controlling the overall operation of the social media service provision server 300 or the system 200 for providing the personalized social media service; a temporary area configured to temporarily store data generated during execution of the control program; and a data area configured to semi-permanently store data necessary for the executing of the control program and the data generated during the execution of the control program. According to the present disclosure, the data area may include a member DB 311, a post DB 312, a book DB 313, a content DB 314, and the like.

The member DB 311 stores member information of members who have subscribed to a book-based personalized social media service according to the present disclosure.

The post DB 312 stores posts for each timeline and each user, the posts being posted on the social media web page displayed on a screen of the connected user terminal unit 100 according to the present disclosure.

The book DB 313 stores book management information for each user according to the present disclosure, the book management information including: user timeline management information for storing books created for each user and managing the particularly created books by categorizing according to a user's timeline; library management information for categorizing the books by character (i.e., alphabet, Korean alphabet, and the like) order, generation date, and the like according to a user's taste, and managing the books in the form of a library; and bookshelf management information for managing the books a user desires among the books in the library for each user by means of grouping, and managing the books in the form of a bookshelf.

The content DB 314 stores content such as images, videos, documents, and the like, which are used by each user.

The communication unit 320 is configured to connect to the wired/wireless data communication network 10 and enable mutual data communication with the user terminal unit 100 connected through the wired/wireless data communication network 10.

The controller 400 includes a platform provision unit 410, a post event monitoring unit 420, a post generation unit 430, a post web page generation unit 440, a management means generation unit 450, and a book management unit 460, and controls overall operations of the social media service provision server 300 and the system 200 for providing the personalized social media service according to the present disclosure.

Specifically, the platform provision unit 410 includes: a web page provision unit 411 configured to provide a social media web page on which a plurality of posts is posted to a connected user terminal unit 100; and a book viewer provision unit 412 configured to provide a book viewer when the posted posts are books, so that the books, as the posts, having a plurality of pages may be viewed through turning pages left and right.

The web page provision unit 411 may provide a social media web page as shown in FIG. 5. FIG. 5 is a view illustrating a case where a first post 501, a second post 502, and a third post 503, which are on the social media web page, are all books 1.

In addition, the platform provision unit 410 provides a comment input means 511 for each of the posted posts, and may further include a comment processing unit 413 configured to post, at a lower end of a corresponding post, a comment 512 input through the comment input means 511.

The post event monitoring unit 420 monitors whether a post event occurs, the post event requesting the writing of a post on the social media web page. The post event may occur by a post writing button, a book creation button, and the like.

The post generation unit 430 includes a web post generation unit 431 and a book creation unit 432.

When a post event is determined as a general post writing event through the post event monitoring unit 420, the web post generation unit 431 provides a post generation GUI to a user terminal unit, and generates a general post through the post generation GUI.

When the post event is a book creation event, the book creation unit 432 provides a book creation GUI as shown in FIG. 4 to the user terminal unit 100, and through the book creation GUI, creates a two or more page book that performs page transitions by turning pages from left to right, or right to left as shown in FIG. 6 within the same post, so as to store the book in the book DB 313.

Referring to FIG. 3, the book creation unit 432 includes a book page generation unit 510, a text writing unit 520, a content attachment unit 530, a link attachment unit 540, a book page combination unit 550, and an image edition unit 560.

The book page generation unit 510 provides the book creation GUI as shown in FIG. 4 to the user terminal unit 100 when a book creation event occurs, but a blank page (or “book page”) 401 is generated and provided together.

The text writing unit 520 receives input text by providing a text box 402 when a user selects to write the text, and receives a designated position of the text box 402 within a book page, so as to arrange the text box to the position of the book page, whereby the text is arranged in the designated position. As described above, the text writing unit 520 may receive text, i.e., characters, and then receive a designated position, or may receive the characters input after receiving the designated position.

The content attachment unit 530 receives selection of content from the user terminal unit 100 when the user selects to attach the content, receives a designated position in the book page to which the content is to be attached, and attaches the content to the designated position. The content may be an image, a video, a document, or the like.

The content attachment unit 530 may include any one or more of an image attachment unit 531, a video attachment unit 532, a document attachment unit 533, and a link attachment unit 540.

When the user selects an image through the user terminal unit 100, the image attachment unit 531 receives any one or more of an arbitrary position and size within the book page from the user, attaches by inserting the image 403, which is the content selected by the user, to the corresponding position in the corresponding size, or attaches the image as an attached file. The attached image may be configured to occupy the entire book page.

When the user selects a video through the user terminal unit 100, the video attachment unit 532 receives any one or more of an arbitrary position and size within the book page from the user and attaches by inserting the video, which is the content selected by the user, to the corresponding position in the corresponding size, or attaches the video as an attached file as in the third post 503 of FIG. 5. The video may also be inserted by designating a part or the entire size of the book page.

When the user selects a document through the user terminal unit 100, the document attachment unit 533 receives any one or more of a designated arbitrary position and size within the book page from the user and attaches by inserting the document, which is the content selected by the user, to the corresponding position in the corresponding size, or attaches the document as an attached file as shown in the third post 503 of FIG. 5.

The link attachment unit 540 attaches by inserting, to an arbitrary position in the book page, a link storing any one of the image, video, and document, which are selected by the user according to user's selection.

The book page combination unit 550 creates a book by combining at least two or more book pages as shown in FIG. 6 when the generation of the book pages is completed. When generating a first book page, the book page combination unit 550 may be configured to combine an arbitrary cover page indicating a book page, so as to create a book including two or more book pages.

The image edition unit 560 activates an image edition GUI in the book creation GUI, and may allow an image inserted or to be inserted into the book page to be edited according to the image edition GUI. The image edition unit 560 may be configured to allow the resolution, size, saturation, brightness, luminance, color, and the like of an image to be edited through the image edition GUI.

The post web page generation unit 440 generates a social media web page including any one generated post among the book posts and general posts generated by the post generation unit 430, so as to store the generated social media web page in the post DB 312, and then provides the generated social media web page to the user terminal unit 100. The page displayed in the post of the social media web page may be configured to be the first page or may be configured to be a page last viewed by a user who viewed the corresponding book.

The management means generation unit 450 includes a library generation unit 451, a bookshelf generation unit 452, and a timeline generation unit 453, is configured to generate management information for the created book according to the user's selection, and map the management information for the user to one or more books of the user, so as to store a mapped result in the book DB 313.

That is, the timeline generating unit 453 generates timeline management information in which the books generated for each user are arranged in timeline order, so as to store the generated timeline management information in the book DB 313, and generates management information in which the posts posted on the web page are arranged in the timeline order, so as to store the generated management information in the post DB 312.

As shown in FIGS. 7 and 8, the library generation unit 451 generates a library 701 including library management information in which books are arranged in the form of a library according to setting information set by a user for the books generated for each user, so as to store the library 701 in the book DB 313. The library 701 may include a bookshelf 702 as shown in FIGS. 7 and 8 when the user generates the bookshelf 702. The setting information may be the sorting and arrangement setting information such as alphabetical or Korean alphabetical order arrangement, generation date order arrangement, recently read order arrangement, and the like, and may be display-related setting information such as a library icon, and the like.

As shown in FIGS. 7 and 8, the bookshelf generation unit 452 groups, in the form of a bookshelf, books selected by the user among the books included in the library, and generates the bookshelf including bookshelf management information that is management information for the grouped books, so as to register the bookshelf in the library.

The book management unit 460 deletes a book and a bookshelf, which are registered in the library 701, or provides a means for customizing the bookshelf according to the user's taste as shown in FIG. 8, so as to make the books stored in the library manageable. For example, the book management unit 460 may customize the bookshelf 702 as shown in 702-1 to 702-4 in FIG. 8.

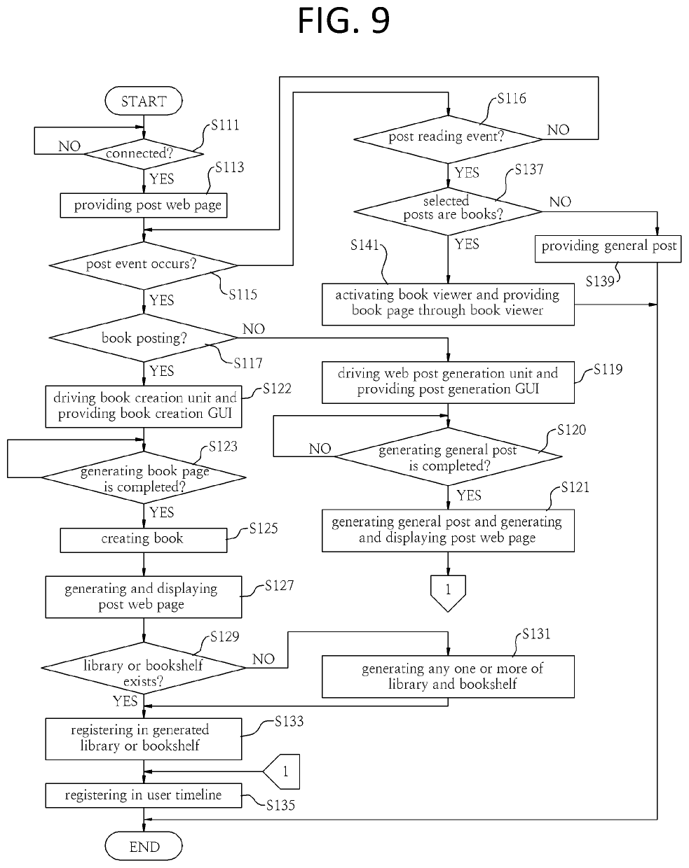

FIG. 9 is a flowchart illustrating a method of providing a book-based personalized social media service according to the present disclosure.

Referring to FIG. 9, in step S111, the controller 400 monitors whether a user terminal unit 100 is connected.

In step S113, when it is determined that the user terminal unit 100 is connected, the controller 400 provides a post web page as shown in FIG. 5 to the user terminal unit 100.

When the post web page starts to be provided to the user terminal unit 100, the controller 400 checks whether a post event occurs in step S115, and checks whether a post reading event occurs in step S116.

When the post event occurs, the controller 400 determines whether the post event is book posting in step S117, and when the post event is not the book posting, the controller 400, in step S119, drives the web post generation unit 431 and provides a post generation GUI to the user terminal unit 100.

After providing the post generation GUI, the controller 400 monitors to determine whether writing a general post is completed in step S120, and when the writing of the general post is completed, the controller 400 generates the general post, generates a post web page including the generated general post, and then transmits the post web page to the user terminal unit 100 for display in step S121.

Whereas, in the case of the book posting, the controller 400 drives the book creation unit 432 and provides the book creation GUI to the user terminal unit 100 in step S122.

When the book creation GUI is provided to the user terminal unit 100, the controller 400 checks whether generating book pages is completed in step S123, and when the book pages are generated, the controller 400, in step S125, creates a new book including the book pages or creates a book by adding the created book pages to an existing book when the user selects a post that is the existing book and selects the adding of the book pages.

When the book is created or updated, and stored in the book DB 313, the controller 400 generates a post web page including the created or updated book, and then provides the book to the user terminal unit 100 for display in step S127.

When the book is created, the controller 400 determines whether a library or a bookshelf for a corresponding user exists in step S129, and when there is no library or bookshelf for the corresponding user, the controller 400 generates, in step S131, any one or more of the library and the bookshelf according to the user's setting.

However, in step S133, the controller 400 registers the created book in the library or updates the existing book when only the library exists, and updates and stores the book in the corresponding bookshelf when the book is on the bookshelf and is the existing book.

When the book is stored and registered in any one of the library and the bookshelf, the controller 400 registers the corresponding book in a user's timeline. When a book page is added and updated in the book, it may be configured such that the book may be registered in the timeline every time the book is updated according to the adding of the book page, or the book may be added in the timeline only at the time of the last update and deleted from the previous timeline. In the above description, although a case in which a timeline is generated after a book is registered in a library when creating the book has been described, it may be configured such that the book is registered in the library after being registered in the timeline first.

When it is determined that the post event occurred in step S115 is the post reading event in step S116, the controller 400 determines whether the selected post is a book or a general post in step S137.

As a result of the determination, when the selected post is the general post, the controller 400 transmits the general post to the user terminal unit 100 in step S139, and when the selected post is the book, the controller 400 activates a book viewer, and provides the book page to the user terminal unit 100 through the book viewer in step S141.

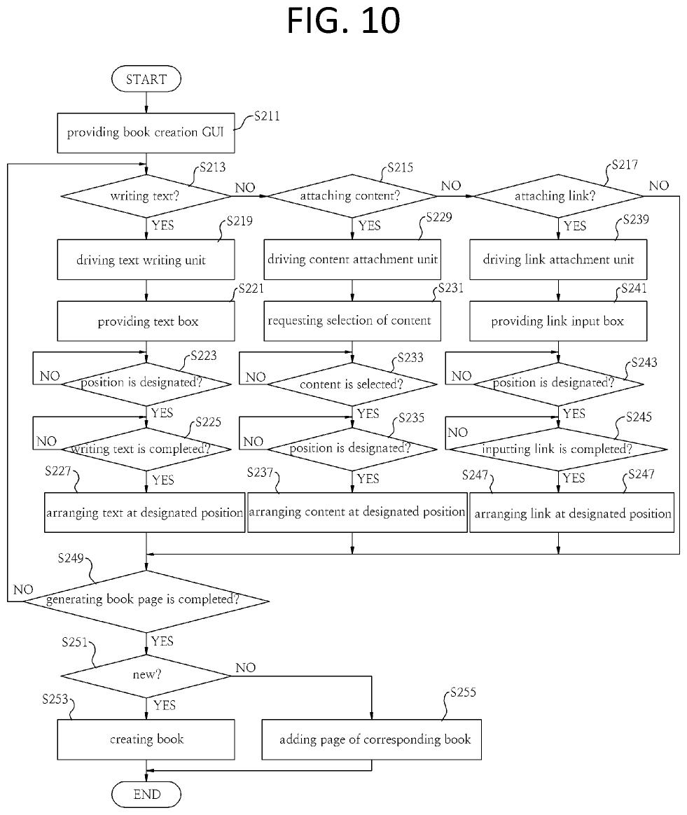

FIG. 10 is a flowchart illustrating a book creation method of the method of providing the book-based personalized social media service according to the present disclosure. The book creation method will be described in more detail with reference to FIG. 10.

First, the controller 400 provides the book creation GUI to the user terminal unit 100 in step S122 of FIG. 9 and in step S211, and then until it is determined that the book page generation is completed or the book page generation is canceled in step S249, the controller 400 checks whether text writing is selected through a button or menu of the book creation GUI in step S213, or checks whether content attachment is selected in S215, or checks whether link attachment is selected in step S217.

When the text writing is selected, the controller 400 drives the text writing unit 520 in step S219.

The driven text writing unit 520 provides a text box at an arbitrary position on a book page in step S221, checks whether the position of the text box is designated in step S223, and checks whether the text writing is completed when the position of the text box is designated in step S225.

In addition, when content attachment is selected, the controller 400 drives the content attachment unit 530 in step S229.

The driven content attachment unit 530 provides a content selection means so as to request selection of content in step S231, and checks whether the content is selected through the content selection means in step S233.

When the content is selected, the content attachment unit 530 checks whether a position is designated in step S235, and arranges the content in the designated position when the position is designated in step S237.

As described above, the content may be an image, a video, a document, and the like, and the content may be attached to a book page in the form of insertion or in the form of an attached file.

In the above description, only the case of inserting the content by selecting the content and designating the position has been described, but the size of the content may be adjusted according to the type of the content.

In addition, when the link attachment is selected, the controller 400 drives the link attachment unit 540 in step S239.

The driven link attachment unit 540 provides a link input box to the user terminal unit 100 to be displayed at an arbitrary position on the book page in step S241, checks whether the position of the link input box is designated in step S243, and checks whether inputting a link is completed in step S245.

When the designating of the position and the inputting of the link is completed, the link attachment unit 540 arranges the link at the designated position of the book page in step S247.

When the book page creation is not completed, the controller 400 returns to the above-described step S213 and repeatedly performs the steps after step S213, so that the new text writing, content attachment, and link attachment may be performed, and the previously-written text writing, content attachment, and link attachment may be modified or deleted.

When the book page creation is completed, the controller 400 determines whether the created book page is a new book page, that is, the first page of the book in step S251.

When it is not a new book page, the controller 400 adds the created book page to the corresponding book in step S255. In this case, the controller 400 may be configured such that the created book page is combined with the last page of the book, or may be configured such that information on the book page to be inserted is input from the user terminal unit 100, and is combined with the book page corresponding to the input book page information.

Whereas, in step S253, when it is a new book page, the controller 400 may be configured such that a new two-page book is created by combining a preset cover or a cover set by the user, and the created book page, and may be configured such that a book having two blank book pages is created together with the created book page as a cover.

Meanwhile, the present disclosure is not limited to the above-described typical preferred exemplary embodiments, but it will be readily understood by those skilled in the art that various improvements, changes, replacements, or additions can be performed within the scope not departing from the gist of the present disclosure. When implementation by such improvement, change, substitution, or addition falls within the scope of the appended claims below, the technical idea should also be regarded as belonging to the present disclosure.

### DESCRIPTION OF THE REFERENCE NUMERALS IN THE DRAWINGS

| | |
|---|---|
| 100: user terminal unit | 110: smart terminal |
| 120: computer terminal | |
| 200: system for providing a | |
| personalized social media | |
| service | |
| 300: social media service | |
| provision server | |
| 310: storage unit | 311: member DB |
| 312: post DB | 313: book DB |
| 314: content DB | 320: communication unit |
| 400: controller | 410: platform provision unit |
| 411: web page provision unit | 412: book viewer provision unit |
| 413: comment processing unit | 420: post event monitoring unit |
| 430: post generation unit | 431: web post generation unit |
| 432: book creation unit | 440: post web page generation |
| | unit |
| 450: management means | 451: library generation unit |
| generation unit | |
| 452: bookshelf generation unit | 453: timeline generation unit |
| 460: book management unit | 600: web server |
| 700: cloud server | |

1. A system for providing a book-based personalized social media service, the system comprising:
a communication unit configured to perform data communication with a plurality of connected user terminal units;
a storage unit comprising a post DB configured to store posts, posted on a social media web page, for each timeline and each user, and a book DB configured to store a book created for each user, and store book management information for each user for the created book; and
a controller configured to provide, to each connected user terminal unit, the social media web page on which a plurality of posts is posted, provide a post writing GUI including a book creation GUI upon request for creating the book, create a two or more page book that performs page transitions by turning pages within a same post through the book creation GUI, so as to store the book in the book DB, generate management information for the created book according to user's selection, maps management information for each user to one or more books of each user, so as to store a mapped result in the book DB before posting the created book on the social media web page as a post, and provide each connected user terminal unit with a book viewer enabling the page transitions by the turning of the pages when the book is selected, so as to enable each user to view a plurality of book pages of the book.

2. The system of claim 1, wherein the controller comprises:
a platform provision unit configured to provide, to each connected user terminal unit, the social media web page on which the plurality of posts is posted, and provide the book viewer when the posted posts are books;
a post event monitoring unit configured to monitor whether a post event for requesting writing of a post on the social media web page occurs;
a post generation unit configured to provide the post writing GUI including the book creation GUI, and create the two or more page book that performs the page transitions by the turning of the pages within the same post through the book creation GUI, so as to store the book in the book DB, when the post event occurs through the post event monitoring unit;
a post web page generation unit configured to generate the social media web page including the created book as the post, so as to store the social media web page in the post DB, and then provide the social media web page to each user terminal unit; and
a management means generation unit configured to generate the management information for the created book according to each user's selection, and map the management information for each user to one or more books of each user, so as to store the mapped result in the book DB.

3. The system of claim 2, wherein the platform provision unit comprises:
a web page provision unit configured to provide, to each connected user terminal unit, the social media web page on which the plurality of posts is posted; and
a book viewer provision unit configured to provide the book viewer for performing a plurality of page transitions by the turning of the pages within one post when a selected post is a book type post in a case of selecting the post on the social media web page provided through the web page provision unit.

4. The system of claim 2, wherein the post generation unit comprises:
a web post generation unit configured to provide a post generation GUI to each connected user terminal unit and generate a general post through the post generation GUI when the post event is a general post writing event in a case where the post event occurs through the post event monitoring unit; and
a book generation unit configured to provide the book creation GUI to each user terminal when the post event is a book creation event, and create the two or more page book that performs the page transitions by the turning of the pages within the same post through the book creation GUI, so as to store the book in the book DB.

5. The system of claim 4, wherein the book creation unit comprises:
a book page generation unit configured to provide the book creation GUI to each connected user terminal unit, and generate and provide blank book pages together when the book creation event occurs;
a text writing unit configured to receive input text by providing a text box when each user selects to write the text, receive a designated position of the text box in each book page, and arrange the text box at the position of each book page, so as to arrange the text at the designated position;
a content attachment unit configured to receive selection of content from each user when each user selects to attach the content, receive a designated position within each book page to which the content is to be attached, and attach the content to the designated position; and
a book page combination unit configured to create the book by combining at least two or more book pages when the creating of each book pages is completed.

6. The system of claim 5, wherein the content is an image, a video, or a document, and
the content attachment unit comprises any one or more of the following:
an image attachment unit configured to insert and attach the image, which is the content selected by each user, to an arbitrary position within each book page according to each user's selection, or attach the image as an attached file;
a video attachment unit configured to insert and attach the video, which is the content selected by each user, to the arbitrary position within each book page according to each user's selection, or attach the video as the attached file;
a document attachment unit configured to insert and attach the document, which is the content selected by each user, to the arbitrary position within each book page according to each user's selection, or attach the document as the attached file; and
a link attachment unit configured to insert and attach a link for storing any one of the image, video, and document, which are the content selected by each user, to the arbitrary position within each book page according to each user's selection.

7. The system of claim 6, wherein the book creation unit further comprises:
an image edition unit configured to load and display the image attached in a form of insertion or a file through the image attachment unit, provide an image edition GUI capable of editing any one or more of a size, resolution, color, saturation, brightness, a layer, transparency, and an outline shape of the loaded image, and reapply the image edited through the image edition GUI to each book page.

8. The system of claim 2, wherein the management means generation unit comprises:
a timeline generation unit configured to generate management information in which books created for each user are arranged in a timeline order, so as to store the management information in the book DB; and
a library generation unit configured to generate a library including the management information in which the books are arranged according to setting information set by each user for the books created for each user, so as to store the library in the book DB.

9. The system of claim 8, wherein the management means generation unit further comprises:
a bookshelf generation unit configured to group the books selected by each user among the books included in the library, generate a bookshelf including the grouped books, so as to register the bookshelf in the library.

10. A method for providing a book-based personalized social media service, the method comprising:
providing a platform, wherein, a controller provides, to connected user terminal units, a social media web page on which a plurality of posts is posted, and provides a book viewer when the posted posts are books;
monitoring a post event, wherein the controller monitors whether the post event for requesting writing of each post on the social media web page from each user terminal unit occurs through a post event monitoring unit;
generating each post, wherein when the post event occurs through the post event monitoring unit, the controller provides a post writing GUI including a book creation GUI to each user terminal unit through a post generation unit, and creates a two or more page book that performs page transitions by turning pages within a same post through the book creation GUI, so as to store the book in a book DB;
generating a post web page, wherein the controller generates the social media web page including a book generated through the post web page generation unit as each post, so as to store the social media web page in a post DB, and then provides the generated social media web page to each user terminal unit; and
generating a management means, wherein the controller generates management information for the created book according to user's selection through the management means generation unit, and maps the management information for each user to one or more books of each user, so as to store a mapped result in the book DB.

11. The method of claim 10, wherein the providing of the platform comprises:
providing a web page, wherein the platform provision unit of the controller provides the social media web page in which the plurality of posts is posted to each user terminal unit connected through the web page provision unit; and
providing the book viewer, wherein when the selected post is a book-type post in a case where a post on the social media web page provided through the web page provision unit is selected, the platform provision unit of the controller provides the book viewer that performs a plurality of page transitions by the turning of the pages within one post through a book viewer provision unit.

12. The method of claim 10, wherein the generating of the post comprises:
generating a web post, wherein when the posting event is a general posting event in a case where the post event occurs through the post event monitoring unit, the post generation unit provides a post generation GUI to each user terminal unit through a web post generation unit, and generates a general post through the post generation GUI; and
generating a book, wherein when the post event is a book creation event, the post generation unit provides the book creation GUI to each user terminal unit through a book creation unit, and creates the two or more page book that performs the page transitions by the turning of the pages within the same post through the book creation GUI, so as to store the book in the book DB.

13. The method of claim 12, wherein the creating of the book comprises:
generating book pages, wherein when the book creation event occurs, the book creation GUI is provided to each user terminal unit, and a blank book page is generated and provided together;
writing text, wherein when each user selects to write the text, a text box is provided, so as to input the text, a position of the text box is designated within the book page, the text box is arranged at the designated position, so as to arrange the text at the designated position;
attaching content, wherein when each user selects to attach the content, the content is selected from each user, a position in the book page to which the content is to be attached is designated, and the content is attached to the designated position; and
combining the book pages, wherein when the generation of the book pages is completed, at least two or more book pages are combined so as to create a book.

14. The method of claim 13, wherein the content is an image, a video, or a document, and the attaching of the content comprises any one or more of the following:
attaching an image, wherein the image, which is the content selected by each user, is inserted and attached to an arbitrary position in the book page according to each user's selection, or is attached as an attached file;
attaching a video, wherein the video, which is the content selected by each user, is inserted and attached to the arbitrary position in the book page according to each user's selection, or is attached as the attached file;
attaching a document, wherein the document, which is the content selected by each user, is inserted and attached to the arbitrary position in the book page according to each user's selection, or is attached as the attached file; and
attaching a link, wherein the link for storing any one of the image, video, and document, which are the content selected by each user, is inserted and attached to the arbitrary position in the book page according to each user's selection.

15. The method of claim 14, wherein the creating of the book further comprises:
editing an image, wherein the image attached in a form of insertion or a file is loaded and displayed through the image attachment unit, an image edition GUI capable of editing any one or more of a size, resolution, color, saturation, brightness, a layer, transparency, and an outline shape of the loaded image is provided, and the image edited through the image edition GUI is reapplied to the book page.

16. The method of claim 10, wherein the generating of the management means comprises:
generating a timeline, wherein the management information in which books created for each user are arranged in a timeline order is generated, so as to store the management information in the book DB; and
generating a library, wherein the library including the management information in which the books are arranged according to setting information set by each user for the book created for each user is generated, so as to store the library in the book DB.

17. The method of claim 16, wherein the generating of the management means further comprises:
generating a bookshelf, wherein the books selected by each user among the books included in the library is grouped, the bookshelf including the grouped books is generated, so as to register the bookshelf in the library.
